(19) United States
(12) Patent Application Publication
(10) Pub. No.: US 2006/0288210 A1
(43) Pub. Date: Dec. 21, 2006

(54) System of personal data spaces and a method of governing access to personal data spaces

(76) Inventor: Igor Hansen, Broxburn (GB)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/446,362

(22) Filed: Jun. 5, 2006

Related U.S. Application Data
(63) Continuation-in-part of application No. 10/433,615, filed on Dec. 30, 2003, now abandoned.

(30) Foreign Application Priority Data
Jan. 11, 2001 (PL) P-345054

(51) Int. Cl. H04L 9/00

(52) U.S. Cl. 713/168

(57) ABSTRACT

A system of personal data spaces (PDB) utilizing known storage spaces is characterized by the fact that it consists of the sum of unitary personal data spaces, each of which comprises the owner (P) of the unitary personal data space (UPDB) and the storage space (S) of the owner (P) of the unitary personal data space (UPDB), wherein each storage space (S) contains individually encrypted data objects and the storage spaces of various unitary personal data spaces may be situated in one place or they may be distributed. The method of managing access to the personal data spaces is based on this, that the sole owner (P) of the unitary personal data space (UPDB), especially the individual entity whom the data concern and/of whose property they are, exercises the original right of access to the storage space (S) through the granting or withdrawal of access licenses (L) to data objects (0) in the storage space (S). The license (L) determines the scope and conditions of access to the data object (0) in the storage space (S), wherein each creation of a data object in the unitary personal data base space (UPDB) is automatically accompanied by an access license (L) to that data object granted to the owner (P) of the unitary personal data space (UPDB). Data objects in the storage space (S) are protected by symmetrical cryptography, and access to the data objects in the storage space (S) is protected by asymmetrical cryptography. Access to the data takes place only at the point of use of the data (PUD) through the fetching of the data object (0) from the storage space (S) in encrypted form and the consequent decryption of the data object (0).

### RELATED APPLICATION

This application is a continuation-in-part of U.S. patent application Ser. No. 10/433,615 filed on Dec. 30, 2003, which is a 371 of PCT/PL02/0002 filed on Jan. 10, 2002, each of which are hereby incorporated by reference.

### BACKGROUND OF THE INVENTION

1. Field of the Invention

The invention relates to a system of personal data spaces arranged in multi-access configurations of various possible scopes, for example on the Internet or a local or internal network, or even within one appliance, and to a method of governing access to the personal data spaces by individual entities who are the owners of the unitary personal data spaces. These owners can be persons, groups of people, organizations or devices.

2. Description of Related Art

In the conventional systems used until now, the controller of the personal data concerning a subject is the entity physically owning the media used for the storage of the data. Traditional databases may be centralised or distributed with respect to the entity controlling the database, and are usually distributed with respect to the subject of the data. Due to the institutional centralisation of administration and alienation of the subjects which this causes, conventional databases storing personal data, in the principle of their operation violate the rights of the individual citizen, and require additional security measures, legal safeguards, and procedures, in order to ensure the observation of these rights. The dynamic growth of the Internet and its widespread acceptance at every level and in every aspect of society have revolutionised global and regional communications, making easier the storage of information, including personal data, on servers in any place in the world, which can then be read by users from any place in the world. This ease of access to information has given rise to a significant development of systems for controlling access to data, for effectively preventing illegal access, and also of methods of verifying documents in electronic form. The problem of controlling access to data in the computer network has been widely discussed in the literature. Certain particular aspects of this problem were taken up in the description of the Polish invention nr P-331496 PCT/GB97/00164), wherein was set out a system containing: the elements for establishing the first communications connection between a client's computer and the server's computer, elements needed to send a request from the client to the server for the obtaining of data object from the server by the client, elements in the server for selecting the requested data object from the storage memory in response to the request from the client, elements in the server to bind each data object in the memory with the service telephone number, elements in the server for identifying the telephone number of the subscriber submitting the request, other elements for the establishment of a second connection between the sever and the telephone device, elements in the server for the control of the telephone system and elements for the delivery of the requested data object from the server to the client. Data processing systems protect the data by performing an encryption operation on the plaintext of the input data object, using an encryption key, and create the encrypted ciphertext on the output. The recipient of the information in ciphertext form performs the corresponding action of decryption, using the decryption key, in order to retrieve the plaintext of data object. Encryption systems belong to two broad categories. Symmetrical cryptography uses a single key for the encryption of the data object and for its subsequent decryption. It is usually fast and inexpensive, and is used for the basic encryption of large objects, but with an eye to safety and difficulty of management, it is rarely used on its own. Asymmetrical cryptography uses a pair of keys comprising the public and the private keys. The data object encrypted using the public key can be decrypted only with the private key and vice-versa. Asymmetrical cryptography is generally stronger than symmetrical, but it is more complicated in calculation, and therefore fairly slow, lending itself to the encryption of small objects only. Moreover, there exist methods for recovering keys using asymmetrical cryptography. One of them has been set out in the description of the Polish invention P-331313 (PCT/GB97/01982), wherein is shown a system for recovering the cryptographic key, working with existing systems designed for establishing keys between communicating sides. Further, one of the methods of verifying electronic documents has been set out in the description of the Polish invention P-326075 (PCT/US96/14159). That invention concerns, in principle, a system of verification of the document, a system of its archival and locating, a method of authenticating documents sent electronically, a method of authenticating the electronic document, a device for the authentication of the electronic document and a method for realising transactions through the sending of authenticated information objects and use of the device tools for the realisation of this transaction. The system ensures authenticity, privacy and integrity of the transmitted information. By authenticity should be understood the verification of the identity of the one signing the document. By privacy should be understood the protection against unauthorised access of the information contained in the document, and by integrity should be understood the facility to uncover any changes whatsoever in the content of the document. The most commonly used physical medium for the transfer of the key is a smart card with an electronic circuit. Under the designation “card” should be understood generally, any material object in the form of a portable tool, which used to carry the key or a part of the key. Smart cards are increasingly being used for performing electronic transactions. A description of one of such cards and the method of performing transactions using it is set out in the description of the Polish invention P-336938 (PCT/SE98/00897).

### SUMMARY OF THE INVENTION

The object of the invention is the creation of a system of personal data spaces founded on recognised computer technologies. The application of the system will be a natural, physical incarnation of the right of every citizen to the ownership, protection and management of his own personal data. The administration of access is based on the principle that each personal data space is centralised from the point of view of its owner and administrator, being the individual entity whom the data concern. At the same time such unitary data space forms a component of a distributed system of data spaces from the point of view of other entities accessing the data by virtue of access licences granted for individual objects.

According to a first aspect of the invention it consists of a system of personal data spaces using known data storage means in which the system consists of the sum of unitary personal data spaces. Each of these abovementioned unitary personal data spaces comprises the owner of the unitary personal data space and the storage space for the data of this unitary personal data space, which the space contains individually encrypted data objects. Storage spaces for different unitary personal data spaces can be situated in one place, for example on one server, or can be distributed, for example on different servers. Thus, the implementation of the personal data spaces is founded on combining known and recognised computer technologies, but its structure transfers the management of data from the owner and manager of the storage and transmission media to the individual entity being the rightful owner of the data.

According to a further aspect of the invention it consists of a method of managing access to personal data spaces. There, the sole owner and ultimate manager of the unitary personal data space, especially the individual whom the data concern and are his own property, exercises the original right of access to his data through the handing out or recalling of access licences to data objects in the storage space. The abovementioned licences define the range and conditions of access to the data objects in the unitary personal data space. A licence of access to the object for the owner of the unitary personal data space compulsorily accompanies every creation of a data object in the unitary personal data space. The said licence can be created automatically, and at the same time as the object and specifically for it, or it can be a pre-existing licence, and the newly created object added to previously licensed data objects. Data objects in the storage space are secured by symmetrical cryptography; and access to the data objects by asymmetrical cryptography. Access to the data happens in the place of use of the data, by the fetching of the data from the storage space in encrypted form and the decryption of the data object. This method of managing access to the personal data spaces provides the protection of each data object still before placing it in the storage space, through encrypting it with an individually generated symmetrical key in the place of this object original creation or introduction. A data object encrypted in this way is subsequently placed in the storage space. Individually generated keys mean that the cost of unauthorised access to data contained in the object or group of objects must be borne for each object or group of objects individually, whereas the placement of an object in storage space requires no special security technologies within the transmission channel. The access licence to a given object contains the value of the symmetrical key used for encrypting the object, which key is itself encrypted using the asymmetrical public key of the licensed entity. A licensee accesses the data by fetching the data object from the storage space in encrypted form, and then decrypting the data object with the symmetrical key previously decrypted from the associated license, using the private asymmetrical key of the licensee. Licences can accompany the data object in the storage space or they can be separately produced and distributed. The giving out of a licence consists of decrypting the symmetrical key in the licence of the data object's owner, through the use of the owner's private asymmetrical key, and then encrypting it again, this time with the asymmetrical public key of the licensee.

### BRIEF DESCRIPTION OF THE DRAWINGS

FIG. 1 sets out a schema of the system of personal data spaces;

FIG. 2 shows a schema of a unitary personal data space accessed by licensed entities;

FIG. 3 shows the application of the invention for storing personal medical data in the context of the patient-owner of the unitary personal data space;

FIG. 4 shows the encryption and decryption of data within the system with the help of symmetrical and asymmetrical cryptographies; and

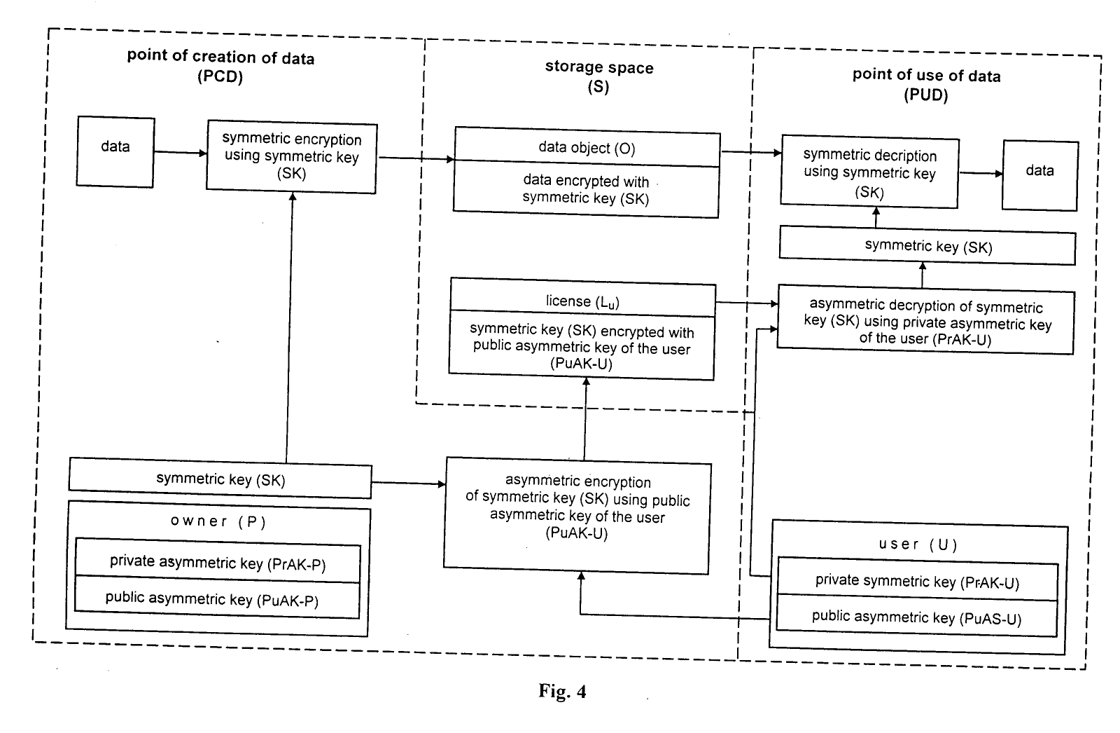

FIG. 5 shows an example application of the invention where three independent data owners hold their data files on an internet server and share between themselves access to selected files.

### DESCRIPTION OF THE PREFERRED EMBODIMENTS

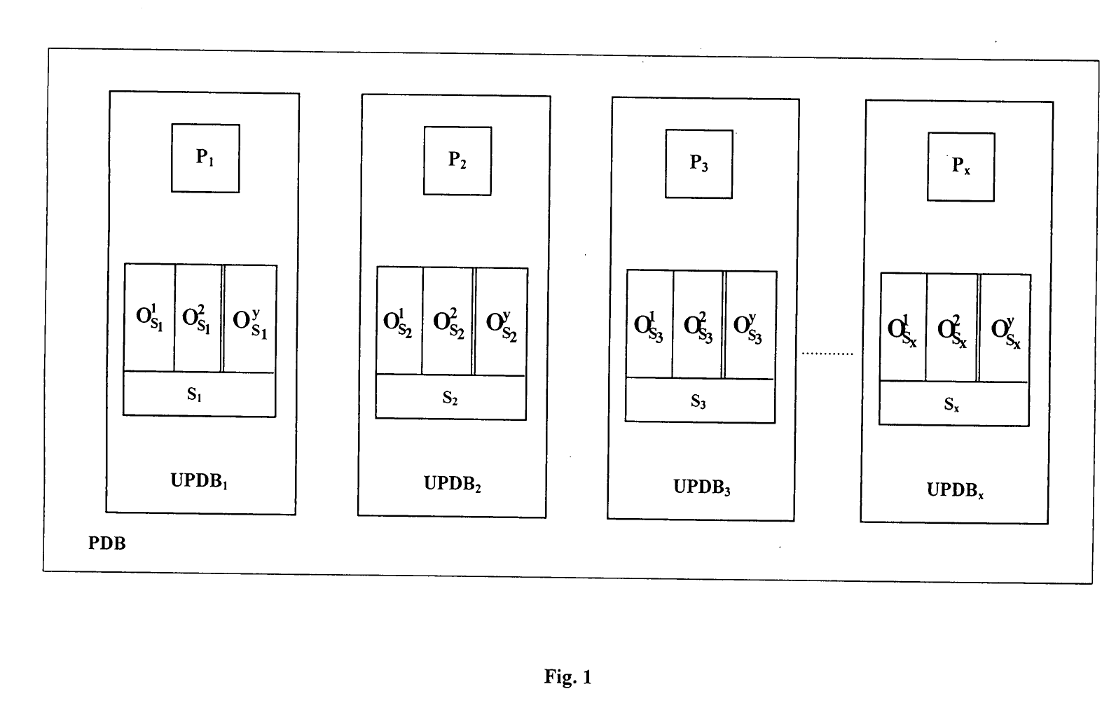

As shown in FIG. 1, the system of personal data spaces PDB comprises the combined unitary personal data spaces UPDB₁, UPDB₂, UPDB₃, . . . , UPDB_{X}, in which each unitary personal data space UPDB₁, UPDB₂, UPDB₃, . . . , UPDB_{X} comprises the owner P₁, P₂, P₃, . . . , Pₓ of the unitary data space UPDB₁, UPDB₂, UPDB₃, . . . , UPDB_{X}, and the storage space S₁, S₂, S₃, . . . , Sₓ of the data of owner P₁, P₂, P₃, . . . , Pₓ of the unitary data space UPDB₁, UPDB₂, UPDB₃, . . . , UPDB_{X}. Each storage space S₁, S₂, S₃, . . . , Sₓ contains individually encrypted objects 0¹,0², . . . , O^{y}. Storage spaces S₁, S₂, S₃, . . . , Sₓ can be situated in one place, for example on one server, on one computer hard disk or one compact disk, or they can be located in various freely chosen places, for example different servers on the Internet.

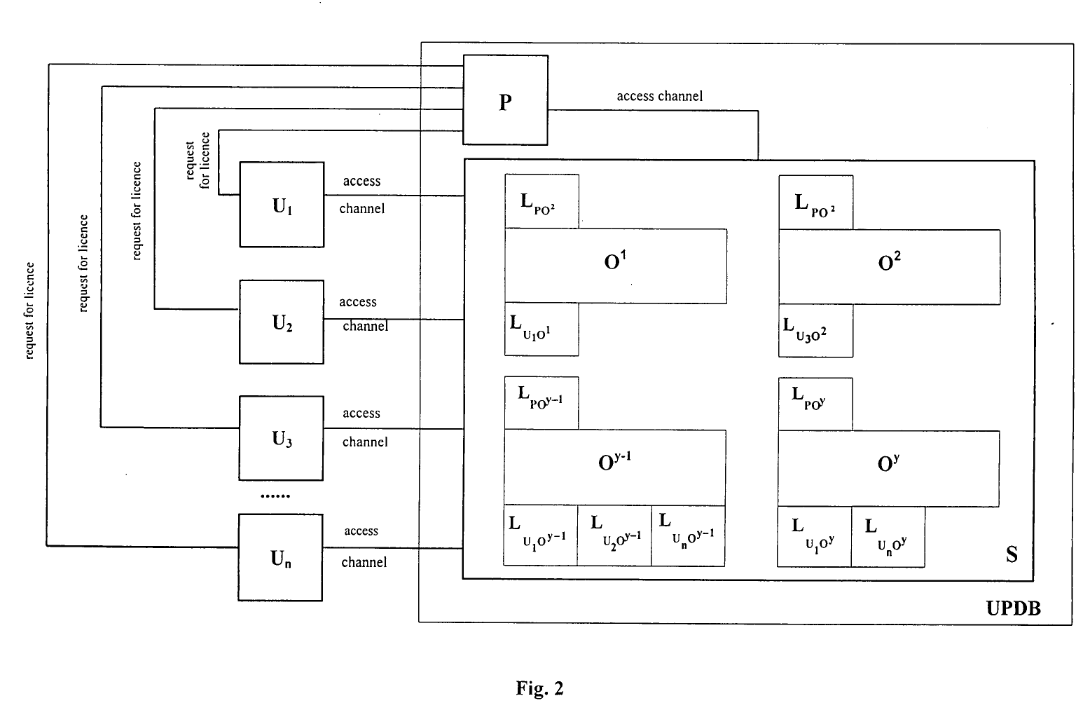

FIG. 2 shows an example unitary personal data space UPDB, whose storage space S contains four data objects 0¹, 0², . . . , O^{Y-1}, O^{Y}. By default, for each of the data objects 0, the owner P possesses a data access control object, called a licence L_{p,0}, correspondingly licence L_{p,0}¹ for object 0¹, licence L_{p,0}² for object 0², licence L_{p,0}^{Y-1} for object 0^{Y-1}, and licence Lₚ,O^{Y} for object O^{Y}. On the other hand, other users U₁, U₂, U₃, . . . , Uₙ, in order to obtain access to data object O in the storage space S, must obtain access licence L_{U,o} from owner P. In the example, the owner P provided access licence Lu_{1,O}¹ for data object 0¹ for the single user U₁ only. For data object 0² he provided access licence L_{U3,}0² for user U₃, whereas for data object 0^{Y-1} he provided access licence L_{U1,}0^{Y-1} for user U₁, access licence L_{u2,}0^{Y-1} for user U₂ and access licence Luₙ,O^{Y-1} for user Uₙ. For data object O^{Y} the owner provided access licence L_{U1,O}^{Y} for user U₁ and access licence L_{Un,O}^{Y} for user Uₙ.

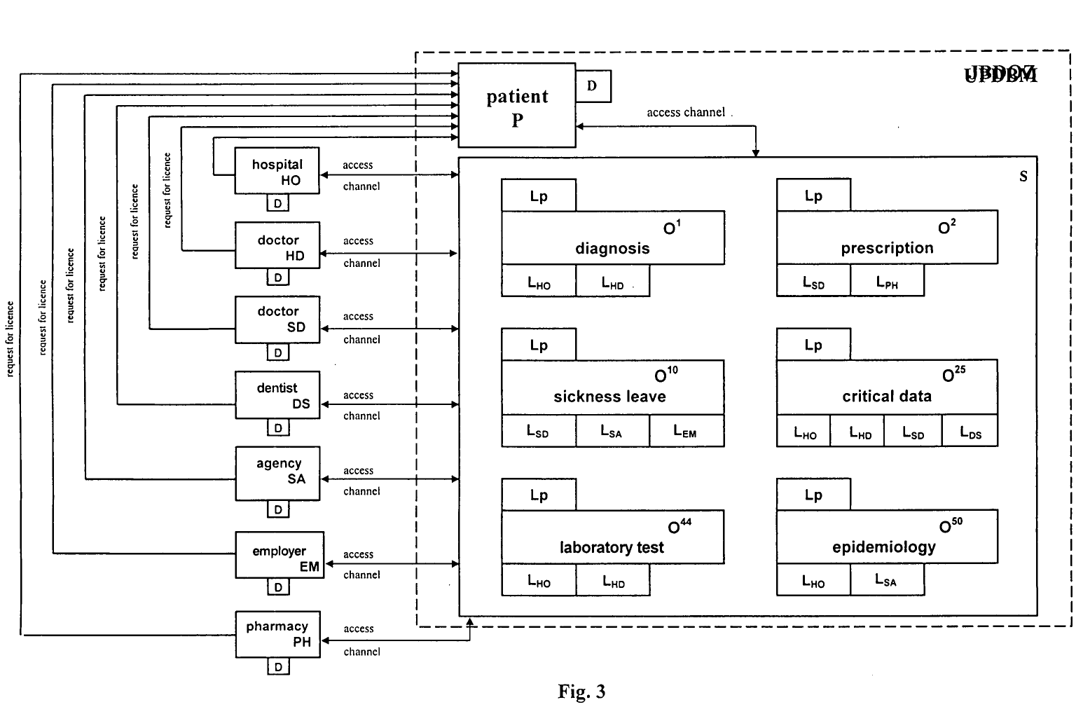

FIG. 3 is analogous to FIG. 2, and it shows example application of the invention to implement a unitary data space of personal medical data UPDBM for the owner-patient P. Data objects O in the particular storage space S are: diagnosis O¹, prescription O², sickness leave O¹⁰, summary of critical medical data O²⁵, laboratory test result O⁴⁴ and epidemiological data O⁵⁰. The users of the data are: Hospital HO, house doctor HD, specialist doctor SD, dentist DS, pharmacy PH, employer EM and statistical agency SA. Patient P and each user: HO, HD, SD, DS, PH, EM, SA has access to a computer connected to the Internet and equipped with a device D enabling the use of cryptography. All data objects stored in the storage space S are individually encrypted; this means that for each object O a separate cryptographic key is created and used. Patient P holds access licence L_{P,O} for all objects O. Hospital HO was given access licence L_{HO,O} to diagnosis O¹, critical data O²⁵, laboratory test result O⁴⁴, and epidemiological data O⁵⁰. Other users: house doctor HD holds access licences L_{HD,O} to diagnosis O¹, critical data O²⁵ and laboratory test result O⁴⁴, specialist doctor SD holds access licences L_{SD},O to prescription O², sickness leave O₁₀ and critical data O²⁵, dentist DS holds access licence L_{DS,O}²⁵ to critical data O²⁵, statistical agency SA holds access licences L_{SA,O} to sickness leave O¹⁰ and epidemiological data O⁵⁰, employer EM holds an access licence L_{Em,O}¹⁰ to sickness leave O¹⁰, and pharmacy PH holds access licence L_{pH,O}² to prescription O₂. The given example does not exhaust the possibilities of utilising the system of personal medical data space UPDBM, but only indicates the method of organisation and management of this system. This is because patient P may provide access licences L to other selected entities on individually set conditions. Licence L can be granted for an indefinite period, it can be made non-revocable to guarantee access by doctors to their own entries or it can be on a one time basis, for example to a doctor outside one's place of residence. Prescription O² can be made accessible to pharmacy PH for the purpose of dispensing medicine, registering this transaction and reconciling the payment with the relevant health care agency. Critical data O²⁵, in situations demanding immediate intervention, can be automatically made accessible to the nearest hospital, which allows it to be appropriately prepared for the reception of the patient P. Epidemiological data O⁵⁰ can be made accessible to selected agencies, while not allowing access to the object containing patient P identity, thus preserving his anonymity. It is implicit, that each licensed entity may obtain access to the data of other owners, stored on the same or other servers, upon obtaining licences from those owners.

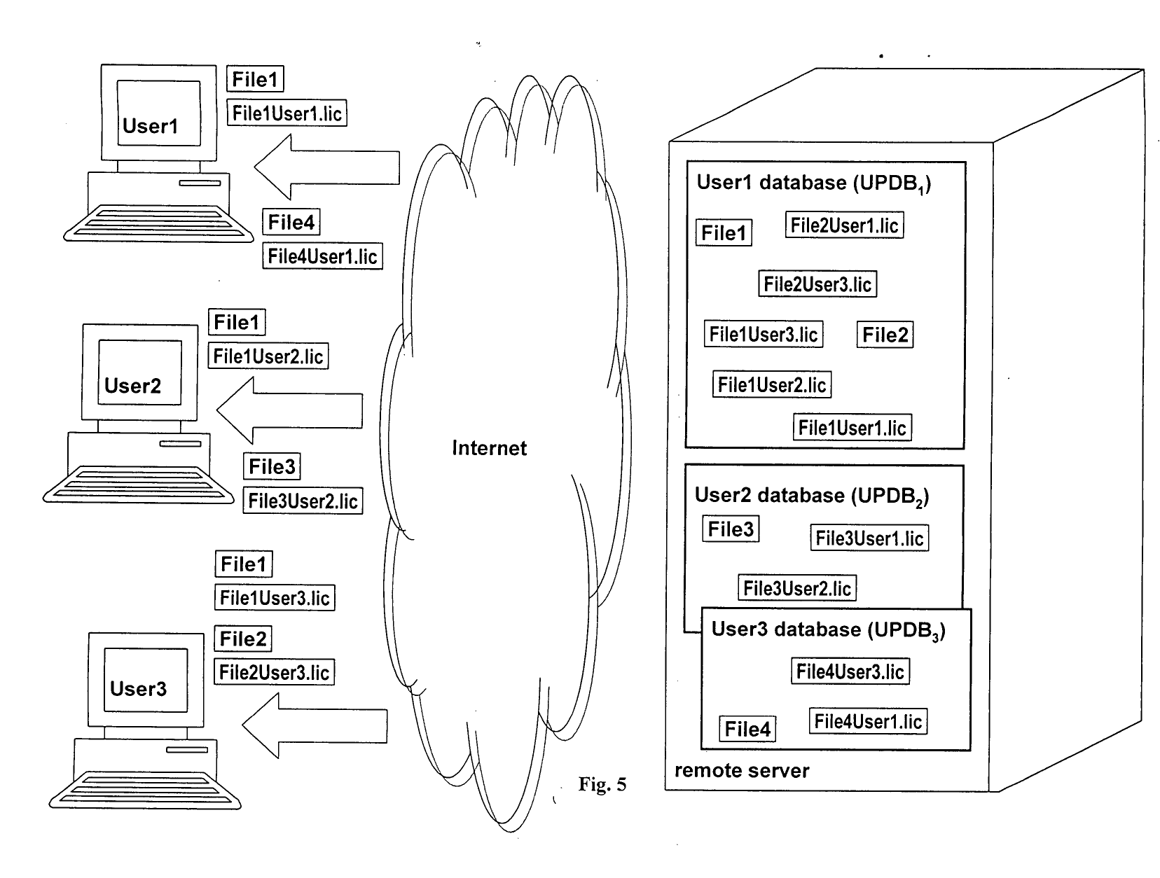

As shown in FIG. 5 User1 hires a unitary personal data space UPDB₁ and uses it to keep data files File1 and File2. File1 is encrypted with symmetric key SK1 and File2 is encrypted with symmetric key SK2. User2 keeps data file File3 in his data space UPDB₂, and this file is encrypted with symmetric key SK3. Similarly, data space UPDB₃ of User3 holds a single data file File4 encrypted with SK4. Access license to any particular file is a separate file containing the appropriate symmetric key SK encrypted with asymmetric public key of the licensee. Therefore User1 is licensed to access all his own files File1 and File2 because his data space contains files File 1User1.lic and File2User1.lic. File File1User1.lic contains key SK1 encrypted with User1 asymmetric public key PuAK-User1 and File2User1.lic contains key SK2 encrypted with the same asymmetric public key PuAK-User1. Similarly, User2 can access his file File3 because his data space contains file File3User2.lic which holds symmetric key SK3 encrypted with PuAK-User2. User3 exercises his ownership right to File4 because of File4User3.lic containing SK4 encrypted with PuAK-User3. User1, User2 and User3 can grant each other rights to access their selected files by placing appropriate individual license files in their own data spaces. For example, User1 granted access to File1 to both User2 and User3 by placing in his UPDB₁ the license files: File1User2.lic and File1User3.lic. File1User2.lic contains SK1 encrypted with PuAK-User2 and File1User3.lic contains SK1 encrypted with PuAK-User3. File2 can be additionally accessed only by User3 because of license file File2User3.lic containing SK2 encrypted with PuAK-User3. User2 has no right to access this file. In a similar way User2 licensed User1 to access his File3 by creating license file File3User1.lic with SK3 encrypted using PuAK-User1. User3 licensed User1 to access File4 through File4User1 lic containing SK4 encrypted with PuAK-User1. When asked to supply a particular data file, the server verifies that appropriate license file exists and supplies it together with the requested data. In the example User1 asked for File1 from his own data space UPDB₁ and for File4 from User3 data space UPDB₃. In return he obtained File1 with File1User1.lic from UPDB₁ and File4 with File4User1.lic from UPDB₃. Similarly, User2 acquired File1 and File1User2.lic from User1 data space UPDB₁ and his own File3 and File3User2.lic from UPDB₂. If he asked for File2 from UPDB₁, the server would refuse because it would not find the appropriate File2User2.lic in User1 data space.

The system of personal data spaces PDB according to the invention can be successfully used for storing documents of especial value to the owner P. Such a data space enables the secure storage of documents, for example those which loss through theft, misplacement or fire would have serious material or legal consequences, or cause a strong feeling of personal loss. Personal documents may be stored in unitary personal data space UPDB by the owner P himself, legal documents such as notarial acts or birth certificates should be first digitally signed by a notary, and identity documents such as an identity card, a passport, driver's licence, certificate of professional qualification or of academic status, should be stored in the unitary personal data space UPDB as duplicates first digitally signed by the body issuing the original document. Documents stored in the unitary personal data space UPDB can be accessed by the owner P anywhere, where the need for them to be shown arises, for example on a national border when the original passport has been lost or stolen. Strong cryptographic technologies will make documents more immune to forgery than paper or plastic based originals and may even end up being used in place of those originals. The system of personal data spaces PDB may be used to protect and licence intellectual property. Computer programmes, digitally recorded audio items, literature, graphic productions, teaching materials and others can be encrypted symmetrically and stored in the unitary personal data space UPDB of the original owner P: the author, agent or studio. From there, the owner P can make these items individually available other licensed users U. For the distribution of encrypted data objects 0, especially repeatedly usable ones, like audio or video material, use can be made of mass media such as the Internet, compact discs, kiosks or Digital Audio Broadcast channels. At this point, the distributed data object 0 still belongs only to the unitary personal data space UPDB of owner P, as its content is only accessible to him and is not accessible by unauthorised entities. Obtaining licence L makes data object 0 accessible to user U. In the case of obtaining many licences L to many different data objects 0 from one or more owners P, such user U becomes the manager of a distributed personal data space comprising a collection of different data objects 0, to which user U gains access by means of his private asymmetrical key PrAK-U.

Another example of utilisation of the invention is in the field of controlling access to motor vehicles, especially motorcars. There, the ultimate manager, and the licensing entity is the owner of the vehicle. The collection of data objects, i.e. the unitary personal data space UPDB contains the full range of functions of the vehicle, in which each function can be treated as a single data object 0; the data recorded therein allow the controlling of the relevant function, and the readings provide indicators of its use. The original owner P of the vehicle and of UPDB data space S within can issue licences L to other entities, modify or revoke them. These may be licences for selected functions with established limits of working, for example limiting speed for young drivers. The full range of functions of the vehicle accessible to the original owner P is his unitary personal data space UPDB. The collection of access licences to many different vehicles, composed of licences given to a third party by the original owners of the vehicles, comprises the distributed personal data space of access of that party.

It is evident, that the system of personal data spaces PDB, as also the unitary personal data space UPDB, can contain data objects Θ from many fields. The same asymmetric key pair can be used to access personal medical data, digital copy of one's passport, to open a musical file one has purchased, to direct a whole fleet of company cars or to manage access to a private vehicle.

1: A system of personal data spaces using known storage media characterised in that the system of personal data spaces (PDB) comprises the sum of unitary personal data spaces, where each unitary personal data space (UPDB) is made up of the owner (P) of this unitary personal data space (UPDB) and storage space (S) for the data of the owner (P) of the unitary personal data space (UPDB), and where each storage space (S) contains data objects, where each object (0) is encrypted with an individually generated symmetric key (SK) and it is also accompanied in that space (S) by one or more separate data access control objects, each such object (L) containing the symmetric key (SK) encrypted with a public asymmetric key (PuAK) belonging to one of the users (U) within the system of personal data spaces (PDB), with each data access control object (L) digitally signed with private asymmetric key (PrAK) of the owner (P) of the unitary personal data space (UPDB) and where at least one of the data access control objects (L) must contain the symmetric key (SK) encrypted with the public asymmetric key (PuAK) of the owner (P) of the unitary personal data space (UPDB).

2: A system according to claim 1 characterized in that all the individual storage spaces of different unitary personal data spaces are situated on one storage media.

3: A system according to claim 1 characterized in that the individual storage spaces of different unitary personal data spaces are distributed on different storage media.

4: A method of managing access to data objects within the system of personal data spaces (PDB), where access is provided to a data object (0) in the storage space (S) within a unitary personal data space (UPDB) of the owner (P) of that unitary personal data space (UPDB) to a user (U) only if data access request is digitally signed with the private asymmetric key (PrAK) of the user (U) and only if there exists in the storage space (S) a data access control object (L) for the data object (0) containing the symmetric key (SK) used to encrypt the object (0), where the key (SK) is encrypted with public asymmetric key (PuAK) of the requesting user (U) and the whole data access control object (L) is digitally signed with private asymmetric key (PrAK) of the owner (P) of the unitary personal data space (UPDB).

5: A method according to claim 4 characterized in that the data access control object (L) additionally defines the scope and conditions of access to the data object (0) within the unitary personal data space (UPDB).

6: A method according to claim 4 characterized in that upon the creation of a data object (0) in the storage space (S) within a personal data space (UPDB) of an owner (P) the system of personal data spaces (PDB) automatically creates a data access control object (L) to the object (0) and for the owner (P) by encrypting the symmetric key (SK), used to encrypt the object (0), with the public asymmetric key (PuAK) of the owner (P) and places that data access control object (L) in the storage space (S) within the unitary personal data space (UPDB) of the owner (P).

7: A method according to claim 4 characterized in that the system of personal data spaces (PDB) provides access to the encrypted object (0) to a user (U) by delivering to him the object (0) together with data access control object (L) for that data object (0) and where the user (U) uses his private asymmetric key (PrAK) to decrypt the symmetric key (SK) contained within the data access control object (L) and then uses that decrypted symmetric key (SK) to decrypt the object (0) itself.
